(19) United States
(12) Patent Application Publication
(10) Pub. No.: US 2013/0290517 A1
(43) Pub. Date: Oct. 31, 2013

(54) NAT TRAVERSAL UNDER TCP FOR REAL TIME STREAMING PROTOCOL

(71) Applicant: NATIONAL TAIPEI UNIVERSITY OF TECHNOLO, (US)

(72) Inventors: Shaw Hwa Hwang, Taipei (TW); Bing Chih Yao, Taipei (TW); Chao Ping Chu, Taipei (TW); Ning Yun Ku, Taipei (TW); Tzu Hung Lin, Taipei (TW)

(21) Appl. No.: 13/651,500

(22) Filed: Oct. 15, 2012

(30) Foreign Application Priority Data
Apr. 27, 2012 (TW) 101115178

(51) Int. Cl. H04L 29/06

(52) U.S. Cl. CPC H04L 29/06517
USPC 709/224

(57) ABSTRACT

The present invention provides an improved RTSP protocol. Concepts and components similar to the SIP proxy server are introduced into conventional RTSP architecture. RTSP proxy server not only can assist RTSP media server under NAT firewall in positioning location and ensure that it can keep the RTSP channel connection but also provide the service about NAT port prediction. Furthermore, a brand new method about TCP traversal through NAT is applied in the improved RTSP in order to solve the peer to peer problem when the client and RTSP media server are both under NAT.

### FIELD OF THE INVENTION

The present invention relates to an NAT (Network Address Translator) traversal under TCP, and more particularly to an NAT traversal for Real Time Streaming Protocol (RTSP) in order to improve the problem that multimedia audio/video messages cannot transmit each other when RTSP media server and client are both under NAT firewall.

### BACKGROUND OF THE INVENTION

Nowadays IP Camera is one of the popular “Internet of Things”. Most of the IP camera use Real Time Streaming Protocol (RTSP) due to the fact that RTSP complies with one-way audio/video communication and streaming condition. In a standard RTSP Internet environment, TCP (Transmission Control Protocol) is the major protocol for transmitting multimedia data, but more and more people set up NAT (Network Address Translator, commonly known as IP router) so as to cause the IP Camera and the client are both under the NAT, therefore IP Camera and the client cannot exchange RTSP messages, and even video/audio RTP packet cannot transmit through TCP directly.

A basic procedure of a conventional RTSP for browser application is shown in FIG. 1. Before the RTSP procedure, the web browser of the client 2178 will ask the media server 2167 for presenting a descriptive file and referring to several continuous-media files, and each continuous-media file will begin with “rtsp://” of URL, then the web browser will call a media playing program according to related messages so as to enter RTSP procedure.

Conventional RTSP requires that the media server 2167 must be a real IP in order to execute the aforementioned basic procedure. If the media server 2167 is a mobile small media server such as IP Camera, the IP Camera may under an IP router (NAT), so the media server will have a virtual IP. If the client is also under an IP router (NAT), RTSP communication for both sides will have problem due to the real IP and port number are unknown to both sides, therefore peer to peer transmission for media packet cannot be achieved.

### SUMMARY OF THE INVENTION

The present invention provides an NAT traversal under TCP for RTSP, the RTSP includes a Login Session, a CallSetup Session, a Media Session and a Cancel Session, and includes a first NAT, a second NAT, an RTSP proxy server, an IE browser (client) is under the first NAT, an IP camera (media server) is under the second NAT; comprising the steps as below:
a. the IP camera (media server) uses an OPTIONS instruction for asking intermittently to the RTSP proxy server for registration and positioning, so that the IE browser (client) can find the correct position of the IP camera when visiting the RTSP proxy server, this is the Login Session;
b. in the CallSetup Session, before the IE browser (client) sends a SETUP message, the IE browser performs a plurality of detecting to the RTSP proxy server in order to detect a rule of the first NAT for allocating a port number;
c. after the plurality of detecting, the port number allocated to the first NAT can be predicted according to the rule of the first NAT for allocating the port number, the real IP of the first NAT and the port number allocated to the IE browser for transmitting audio/video packets are filled into a SETUP packet;
d. the SETUP packet passes through the first NAT to the RTSP proxy server, and then passes through the second NAT to the IP camera (media server);
e. after receiving the SETUP packet, the IP camera (media server) performs a plurality of detecting to the RTSP proxy server to detect a rule of the second NAT for allocating a port number;
f. after the plurality of detecting, the port number allocated to the second NAT can be predicted according to the rule of the second NAT for allocating the port number, the real IP of the second NAT and the port number allocated to the IP camera for transmitting audio/video packets are filled into a 200 OK packet;
g. the IP camera (media server) sends the 200 OK packet to the RTSP proxy server through the second NAT, and then passes through the first NAT to the IE browser;
h. after the IE browser (client) receives the 200 OK packet, an API of a TCP will be started for connecting to the second NAT directly, and a “three way handshaking” will fail, after the failure, the IE browser (client) stops the TCP connection immediately and restart the API of TCP;
i. then the IP camera (media server) starts API of TCP for connecting directly to the first NAT, “three way handshaking” is very likely to be succeeded for traversal the first NAT so as to set up a TCP peer to peer channel for the API of TCP of the IE browser (client);
j. thereafter the IE browser sends a PLAY message through the RTSP proxy server to the IP camera, and the IP camera also sends 200 OK packet through RTSP proxy server to the IE browser, CallSetup Session is finished;
k. next enter the Media Session, the peer to peer channel for TCP is used for transmitting audio/video of the media.
l. when the NAT traversal under TCP for RTSP fails, a plurality of RTP-Relay are added for achieving the NAT traversal.

### BRIEF DESCRIPTION OF THE DRAWINGS

FIG. 1 shows schematically a conventional Internet environment for RTSP.

FIG. 2 shows schematically “Three-way Handshaking” of TCP.

FIG. 3 shows schematically the structure of an improved RTSP according to the present invention.

FIG. 4 shows schematically the Login Session of the improved RTSP according to the present invention.

FIG. 5 shows schematically NAT traversal under TCP for RTSP.

FIG. 6 shows schematically NAT traversal by RTP-Relay for RTSP.

### DETAILED DESCRIPTIONS OF THE PREFERRED EMBODIMENTS

### Introduction to RTSP

Many users of Internet multimedia have the intention to control the playing of the media, especially those who like to use remote controller. They like to pause playing, forward or backward playing, fast forward when playing, fast backward when playing, etc, just like a user to use DVD player to watch movie or use CD player to listen music. In order to let the user to control playing, Real Time Streaming Protocol (RTSP) is used for exchange control messages for playing between the media playing program and the server. Packets in RTSP have two kinds: Request and Response. Request means an RTSP message from the client to the server to express the purpose of the client; while Response means an RTSP message from the server to the client to answer the request of the client.

RTSP defines 6 Requests, including SETUP, PLAY, PAUSE, TEARDOWN, OPTIONS and DESCRIBE, as shown in Table 1.

TABLE 1

| Request | Description |
|---|---|
| SETUP | Set up a new media session, the client and the |
| | server are asked to exchange media format, |
| | channel protocol, port number for media |
| | connection, etc. |
| PLAY | The client informs the server to start media data |
| | transmission. |
| PAUSE | The client informs the sever to pause media data |
| | transmission temporarily. After the pause, the |
| | client can send PLAY to request the server to |
| | continue media data transmission. |
| TEARDOWN | When the client is to stop the media |
| | transmission, the client sendsTEARDOWN to |
| | inform the server stopping the media data |
| | transmission, and stop the media connection. |
| OPTIONS | This request can be used anywhere, can be used |
| | as an RTSP request for free expanding. |
| DESCRIBE | A request for inquiring media format of the |
| | opposite side |

RTSP Response messages are messages from the server for responding the request of the client, as shown in Table 2.

TABLE 2

| Code range | Response | Description |
|---|---|---|
| 100~199 | Informational | The server has received a request, |
| (1xx) | | and the request is processed, but |
| | | the request is not accepted yet. |
| 200~299 | Success | The server accepts the request |
| (2xx) | | from the client. |
| 300~399 | Redirection | The request has to be redirected |
| (3xx) | | to another server for a new URL. |
| 400~499 | Client Error | The request cannot be processed |
| (4xx) | | because of the fault of the client, |
| | | such as the the message is not |
| | | identified, the media is not |
| | | supported or no such person, etc. |
| | | According to the instructions |
| | | from the response message, the |
| | | client can issue a new request to |
| | | retry. |
| 500~599 | Server Error | The request message cannot be |
| (5xx) | | processed because of the fault of |
| | | the server, but the client can send |
| | | the request message to other sever |
| | | for processing. |
| 600~699 | Global Error | The request message cannot be |
| (6xx) | | processed because of the fault of |
| | | the Internet environment, and the |
| | | request message cannot be sent to |
| | | other server or retry. |

### Introduction to the Communication of RTSP

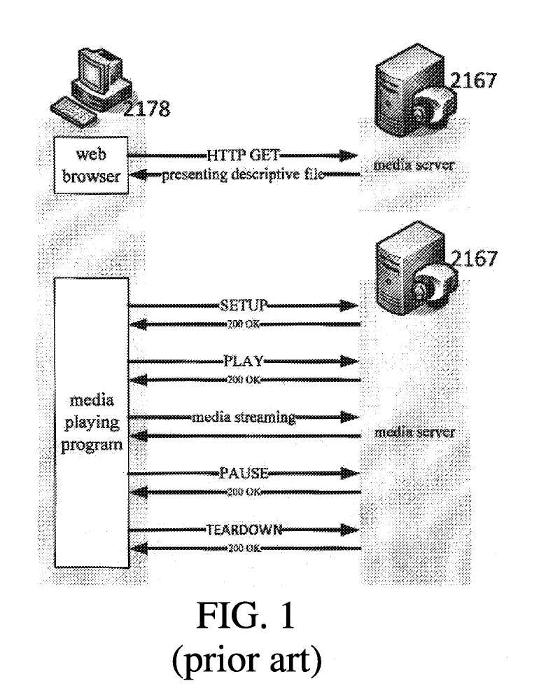

Referring to FIG. 1, a conventional RTSP includes CallSetup Session, Media Session, Cancel Session, but without Login Session. No NAT is set up for IP camera (media server) 2167, IP camera (media server) 2167 has a real IP.

The CallSetup Session is the first session, IE browser (client) 2178 sends SETUP message to IP camera (media server) 2167, a 200 OK message is responded to the client 2178. When the client 2178 is going to play the media, the client 2178 will send PLAY to IP camera 2167, and a 200 OK message is responded to the client 2178.

Thereafter, the client 2178 and IP camera 2167 will enter Media Session, IP camera 2167 sends audio/video media directly to the IE browser of the client 2178.

When the client 2178 is going to stop the audio/video media from IP camera 2167, the client 2178 will send TEARDOWN to IP camera 2167, and then a 200 OK message is responded to the client 2178 to enter the Cancel Session.

### Introduction to “Three-Way Handshaking”

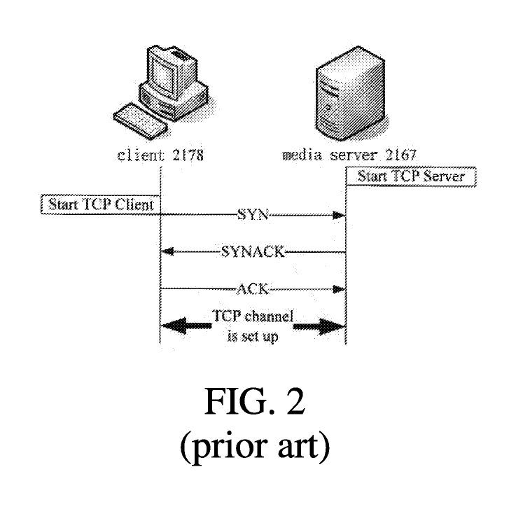

Referring to FIG. 2, when a client 2178 uses TCP (Transmission Control Protocol) to connect with a server 2167, TCP will then conduct “Three-way Handshaking”. Firstly, the server 2167 will start a “Start TCP Server” in API (Application Programming Interface) for setting up a “welcome socket”. In other words, the server 2167 will set up an opened door for waiting the client to enter. When the client 2178 is going to connect with the server 2167, the client 2178 has to start a “Start TCP Client” in API, and sends the information of connecting with the server 2167 to the “Start TCP Client”, thereafter, the client 2178 will initiate “Three-way Handshaking” at the bottom of API.

The client 2178 sends a “SYN” message to the server 2167 to inform the server 2167 for connecting. After the server 2167 is ready, the server 2167 will return a “SYNACK” message to inform the client 2178 “ready for connecting”. Thereafter, the client 2178 will send an “ACK” message to inform the server 2167 “start transmission”, therefore “Three-way Handshaking” is achieved, a TCP channel is set up.

Since TCP connecting is a public standard procedure, the API of TCP will not allow any designer to revise the “Three-way Handshaking”. All actions of the “Three-way Handshaking” are accomplished by the operating system.

### The First Embodiment for an Improved Real Time Streaming Protocol (RTSP)

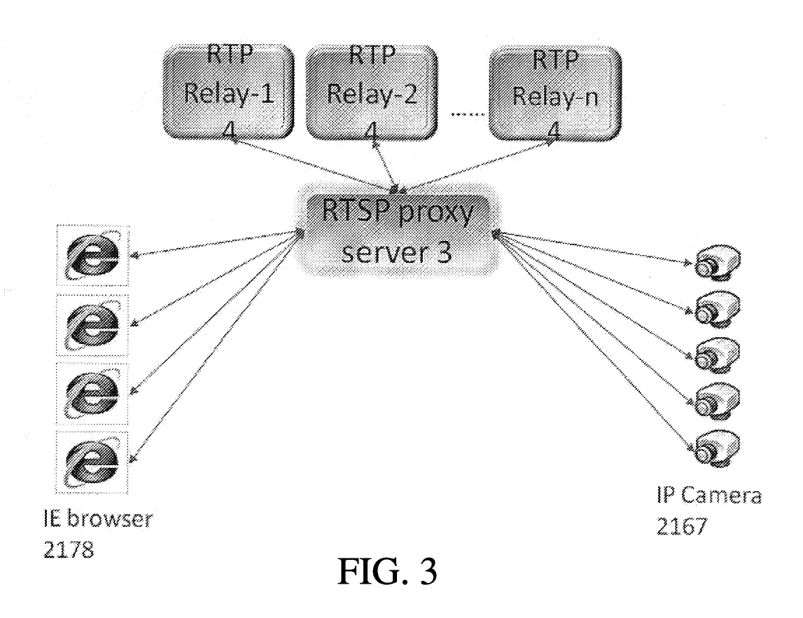

Referring to FIG. 3, in a conventional RTSP, an RTSP proxy server 3 and a plurality of RTP-Relay 4 are added between the IE browser 2178 and the IP camera 2167.

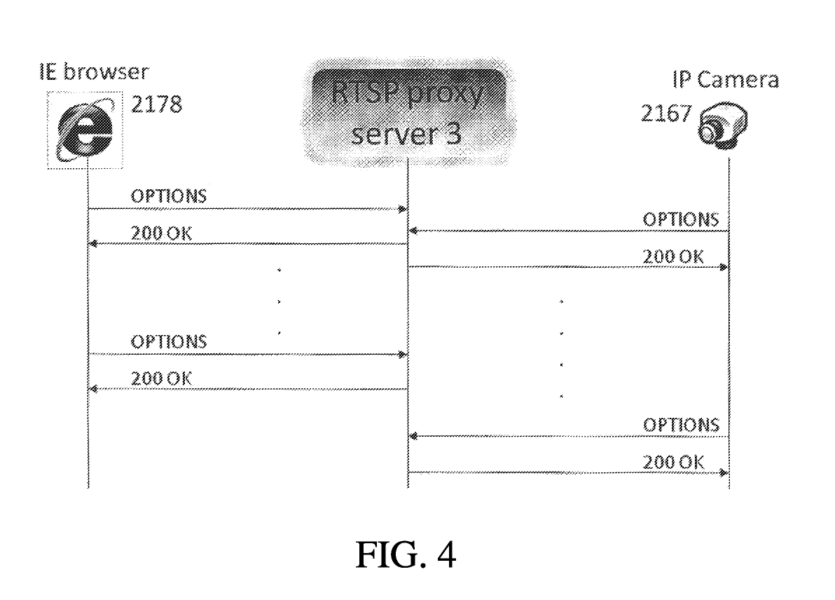

Referring to FIG. 4, besides the three sessions of a conventional RTSP, a new Login Session is added. The IE browser (client) 2178 and the IP camera (server) 2167 use OPTIONS instruction to intermittently send register requests to RTSP proxy server 3 for registration and positioning. The IP camera 2167 is always sending register requests to RTSP proxy server 3 for registration and positioning, while the client (IE browser) 2178 sends register requests intermittently to RTSP proxy server 3 for registration and positioning only when the client 2178 is going to connect with the IP camera 2167.

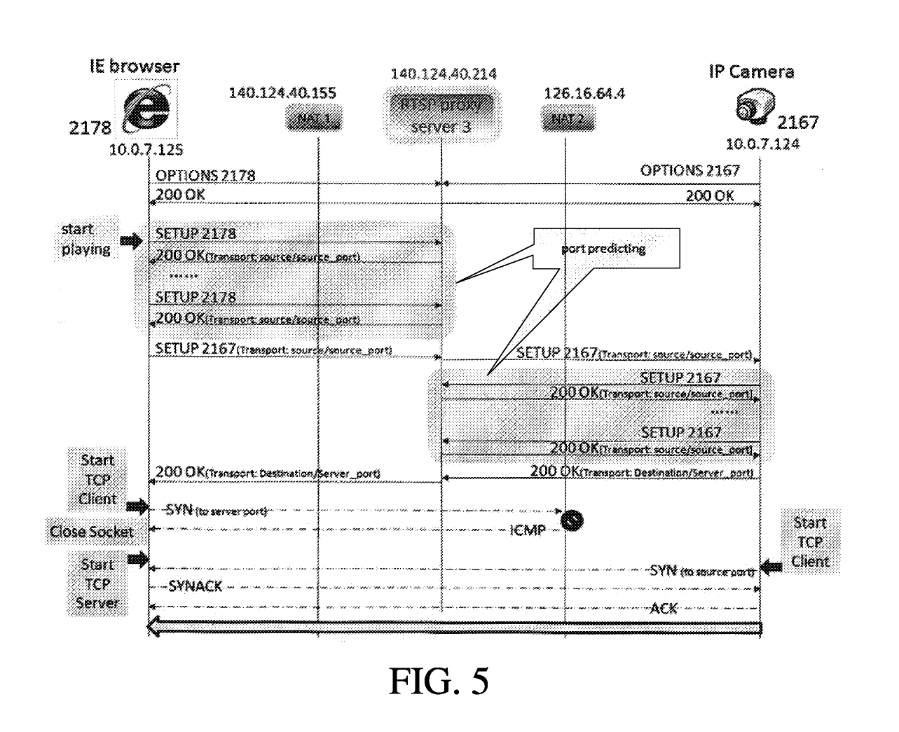

Referring to FIG. 5, NAT traversal under TCP for RTSP according to the present invention is described. Both of the client (IE browser) 2178 and IP Camera 2167 have Login Session for registration and positioning and for exchanging messages through RTSP.

When the client (IE browser) 2178 is going to play the audio/video of the IP Camera 2167, the client 2178 will first predict the port number of NAT 1, and then send SETUP packet to RTSP proxy server 3. The SETUP packet will be first filled with the number 2178, the header is “SETUP 2178 RTSP/1.0”. After the RTSP proxy server 3 receives the SETUP packet, a source IP and port number of the packet will be checked and recorded. The source IP is the real IP address “140.124.40.155” of NAT1, the port number is the port number of NAT 1.

Thereafter, the RTSP proxy server 3 will responded with a 200 OK message to the client 2178, including the source IP and port number of NAT 1, as shown below:

RTSP/1.0 200 OK
........
Transport: RTP/AVP/TCP; unicast; source=140.124.40.155;
server_port=NAT port number

Therefore, the client 2178 will know the port number of NAT 1 after receiving the 200 OK packet. The client 2178 will then send SETUP packet several times in order to detect the rule of the port number allocation.

After predicting the port number, the real IP (140.124.40.155) of the NAT 1 and the port number allocated to the IP camera 2167 are filled into the transport header of SETUP for sending to IP camera 2167, as shown below.

SETUP 2167 RTSP/1.0
CSeq: 302
Transport: RTP/AVP/TCP; unicast; source=140.124.40.155;
server_port=predicted port number

“SETUP 2167 RTSP/1.0” will be sent to RTSP proxy 3 through NAT 1, and then sent to IP camera 2167 through NAT 2. After IP camera 2167 receives messages, IP camera 2167 will also perform the same detecting procedure as the SETUP of the client 2178 for detecting the rule of the port number allocation of NAT 2 of the IP camera 2167.

After predicting the port number, IP camera 2167 will fill the real IP (126.16.64.4) of the NAT 2 and the port number allocated to the client 2178 into the transport header of 200 OK packet for sending to the client 2178, as shown below.

RTSP/1.0 200 OK
CSeq: 302
Date: 23 Jan 1997 15:35:06 GMT
Session: 47112344
Transport: RTP/AVP/TCP; unicast; source=126.16.64.4;
server_port=predicted port number

The 200 OK responding packet transmits messages to RTSP proxy server 3 through NAT 2, and then sends to the client 2178 through NAT 1.

After the client 2178 receives the 200 OK responding packet, an API connection of “Start TCP Client” will be started to connect with 126.16.64.4:(NAT 2 predicted port number). According to “Three-way Handshaking”, an SYN packet will be sent to the NAT 2 predicted port, but because packet in NAT 2 stays at NAT 2, the “Three-way Handshaking” will fail to get an ICMP packet. “Start TCP Client” of API responds an error message, so the client 2178 stop the connection of the socket immediately, and then start “Start TCP Client” again using the same port number to generate a “receiving socket”

Then the IP camera 2167 will follow the “Transport” in SETUP 2167 to “Start TCP Client” for connecting API to 140.124.40.155:(NAT 1 predicted port number). According to “Three-way Handshaking”, SYN packet will pass through NAT 1 predicted port of the client 2178. Since the last SYN for TCP connection from the client 2178 had left the NAT 1 port of the client 2178, and has been recorded in a table of NAT1, therefore a SYN packet from the IP camera 2167 for TCP connection can pass through the NAT 1 port to reach “receiving socket” of the client 2178, and finish “Three-way Handshaking”.

At this moment, a peer to peer TCP channel is set up, the client 2178 can then use the PLAY request to ask the IP camera 2167 to send out media packet and finish the NAT traversal.

### The Second Embodiment for an Improved Real Time Streaming Protocol (RTSP)

The first embodiment is a preferred embodiment, but the predicting of the port number or the traversal will fail sometimes, in this condition, an RTP-Relay method and controlling the flow rate are used for implementing.

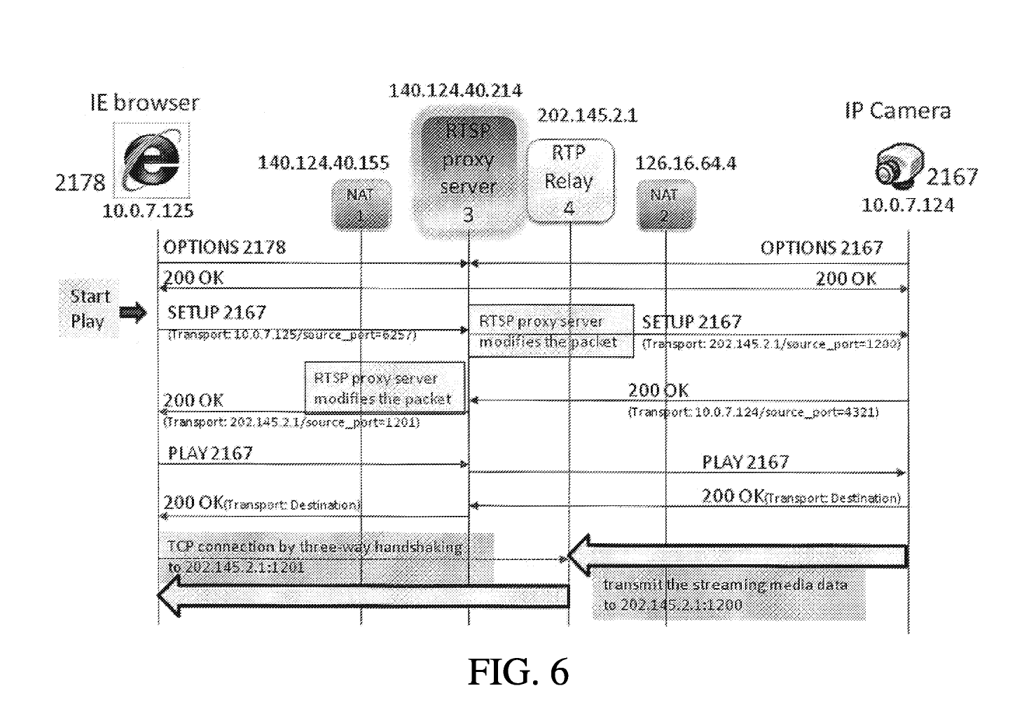

Referring to FIG. 6, both sides use OPTIONS for registration and positioning in order to exchange messages for RTSP. When the client (IE browser) 2178 is ready to play audio/video of the IP camera 2167, a SETUP packet will be sent. The client 2178 will record his IP address (virtual IP) in the Transport header of the SETUP packet as well as the port number for receiving media connection thereafter. The SETUP packet is shown as below.

SETUP 2167 RTSP/1.0
CSeq: 302
Transport: RTP/AVP/TCP; unicast; source=10.0.7.125;
client_port=6257

The SETUP packet passes through NAT 1 to RTSP proxy server 3, and then RTSP proxy server 3 will modify the SETUP packet, the description of the Transport header will be changed into the form of RTP-Relay 4, as shown below:

SETUP 2167 RTSP/1.0
CSeq: 302
Transport: RTP/AVP/TCP; unicast; source=202.145.2.1;
client_port=1200

The modified SETUP Packet is sent to NAT 2 of the IP camera 2167, and finally arrives at IP camera 2167. After receiving the SETUP, IP camera 2167 will respond with 200 OK message. An IP address (virtual IP) of the IP camera 2167 and the port number for transmitting media connection will be filled into the Transport header of the 200 OK message, as shown below:

RTSP/1.0 200 OK
CSeq: 302
Date: 23 Jan 1997 15:35:06 GMT
Session: 47112344
Transport: RTP/AVP/TCP; unicast; source=10.0.7.124;
server_port=4321

The 200 OK packet passes through NAT 2 of the IP camera 2167 to RTSP proxy server 3, and then RTSP proxy server 3 will modify the 200 OK packet, the description of the Transport header will be changed into the form of RTP-Relay 4, as shown below:

RTSP/1.0 200 OK
CSeq: 302
Date: 23 Jan 1997 15:35:06 GMT
Session: 47112344
Transport: RTP/AVP/TCP; unicast; source=202.145.2.1;
server_port=1201

The modified 200 OK packet passes through NAT 1 to the client 2178.

As the client 2178 plays the media, the client 2178 will send PLAY packet through RTSP proxy server 3 to IP camera 2167. After receiving the PLAY packet, IP camera 2167 will respond with 200 OK packet. When the client 2178 receives the 200 OK packet, the client 2178 will start TCP connection to RTP-Relay 4 according to the responding Transport in SETUP, i.e. connect to 202.145.2.1:1201. Therefore a pre-established media TCP channel between the NAT 1 of the client 2178 and RTP-Relay 4 is set up.

When IP camera 2167 starts transmitting streaming media data, the IP camera 2167 will also start TCP connection to RTP-Relay 4 according to the Transport of SETUP packet in CallSetup session, and transmit the streaming media data to 202.145.2.1:1200 one by one. Then RTP-Relay 4 starts to send media data to media TCP channel established between the NAT 1 of the client 2178 and RTP-Relay 4, and finally the streaming media data are sent to the client 2178.

However, it has disadvantage if only the RTP-Relay is used. Suppose that the bandwidth of audio for a media is 2 Mb/sec, expense per month is NT$20000, if there are 1 million users try to download the streaming media data from the media server simultaneously, then the bandwidth expense for RTP-Relay will be NT$20 billion/month, so the second embodiment is only used when the first embodiment is failed.

The special features of the improved RTSP according to the present invention are:
1. Proxy server concept is introduced into conventional RTSP.
2. RTSP proxy server provides services for predicting NAT port number.
3. NAT traversal is used without changing TCP.
4. When NAT traversal under TCP fails, RTP-Relay is used.

The scope of the present invention depends upon the following claims, and is not limited by the above embodiments.

What is claimed is:

1. An NAT traversal under TCP for RTSP, the RTSP includes a Login Session, a CallSetup Session, a Media Session and a Cancel Session, and includes a first NAT, a second NAT, an RTSP proxy server, an IE browser (client) is under the first NAT, an IP camera (media server) is under the second NAT; comprising the steps as below:
a. the IP camera (media server) uses an OPTIONS instruction for asking intermittently to the RTSP proxy server for registration and positioning, so that the IE browser (client) can find the correct position of the IP camera when visiting the RTSP proxy server, this is the Login Session;
b. in the CallSetup Session, before the IE browser (client) sends a SETUP message, the IE browser performs a plurality of detecting to the RTSP proxy server in order to detect a rule of the first NAT for allocating a port number;
c. after the plurality of detecting, the port number allocated to the first NAT can be predicted according to the rule of the first NAT for allocating the port number, the real IP of the first NAT and the port number allocated to the IE browser for transmitting audio/video packets are filled into a SETUP packet;
d. the SETUP packet passes through the first NAT to the RTSP proxy server, and then passes through the second NAT to the IP camera (media server);
e. after receiving the SETUP packet, the IP camera (media server) performs a plurality of detecting to the RTSP proxy server to detect a rule of the second NAT for allocating a port number;
f. after the plurality of detecting, the port number allocated to the second NAT can be predicted according to the rule of the second NAT for allocating the port number, the real IP of the second NAT and the port number allocated to the IP camera for transmitting audio/video packets are filled into a 200 OK packet;
g. the IP camera (media server) sends the 200 OK packet to the RTSP proxy server through the second NAT, and then passes through the first NAT to the IE browser;
h. after the IE browser (client) receives the 200 OK packet, an API of a TCP will be started for connecting to the second NAT directly, and a “three way handshaking” will fail, after the failure, the IE browser (client) stops the TCP connection immediately and restart the API of TCP;
i. then the IP camera (media server) starts API of TCP for connecting directly to the first NAT, “three way handshaking” is very likely to be succeeded for traversal the first NAT so as to set up a TCP peer to peer channel for the API of TCP of the IE browser (client);
j. thereafter the IE browser sends a PLAY message through the RTSP proxy server to the IP camera, and the IP camera also sends 200 OK packet through RTSP proxy server to the IE browser, CallSetup Session is finished;
k. next enter the Media Session, the peer to peer channel for TCP is used for transmitting audio/video of the media.

2. The NAT traversal under TCP for RTSP according to claim 1, wherein when the NAT traversal under TCP for RTSP fails, a plurality of RTP-Relay are added for achieving the NAT traversal.
